(19) United States
(12) Patent Application Publication
(10) Pub. No.: US 2010/0087110 A1
(43) Pub. Date: Apr. 8, 2010

(54) Automatic Deploying and Positioning Slalom Water Ski Course

(76) Inventor: Christopher P. J. BERG, (US)

Correspondence Address: Dane C. Butzer, 11625 Custer #110-341, Frisco, TX, 75035, US

(21) Appl. No.: 12/566,505

(22) Filed: Sep. 24, 2009

Related U.S. Application Data
(60) Provisional application No. 61/102,816, filed on Oct. 3, 2008.
(60) Provisional application No. 61/107,333, filed on Oct. 21, 2008.

(51) Int. Cl. B63B 22/16; G01C 21/00

(52) U.S. Cl. 441/6; 701/213

(57) ABSTRACT

A portable automatic deploying and positioning slalom water ski course that automatically deploys and maintains position. The course preferably includes at least one turn ball span and at least one entry/exit span. Preferably, the turn ball span, the entry/exit span, or both further comprises a location determination device, a control device, and a propulsion device. Also, methods of using the course.

### CROSS REFERENCE TO RELATED APPLICATION

This application claims priority from U.S. Provisional Application No. 61/102,816, filed Oct. 3, 2008, and U.S. Provisional Application No. 61/107,333, filed Oct. 21, 2008, both in the name of Christopher P. J. Berg.

### BACKGROUND OF THE INVENTION

1. Field of the Invention

This invention relates to a portable automatic deploying and positioning slalom water ski course that automatically deploys and maintains position providing an easy to use temporary slalom water ski course.

2. Description of the Related Art

A traditional water ski course can be deployed by manually placing long lengths of ropes, cables, complex rigging, anchors, and the like to form the course. This process is time consuming and cumbersome, as is retrieving these elements after the course has been used.

### SUMMARY OF THE INVENTION

The invention addresses the foregoing issues through a system that automatically deploys to form a water ski course. In a preferred embodiment, the system automatically moves boat guide buoys, turn ball buoys, and/or entry/exit gates into position to form a slalom water ski course when deployed from a boat, dock, or other deployment point. These elements preferably can be activated to return to the deployment point for easy retrieval once a water skiing session is complete.

One embodiment of the invention includes a collection of six “turn ball spans” and two “entry/exit gate spans.” Each of these spans preferably includes buoys that float on the water surface connected to underwater pipes, propulsion systems, and a control system. Each “span” preferably can automatically position itself in such a way that the entire system forms a standard water ski course when deployed. Global positioning system (GPS) receivers and propulsion devices preferably are included at each end of each span, while a computer control system is preferably included within each span helping the system to deploy, to maintain position while being used, and to return to the original deployment point. The invention does not need to be anchored, but preferably will maintain position compensating for movement associated with wind, current, boat waves, and direct or indirect contact by boats, people, animals, or other things. Of course, anchoring can be used if so desired.

### DESCRIPTION OF DRAWINGS

The appended drawings show exemplary embodiments of the invention and are not to be considered limiting of its scope, as the invention may admit to other embodiments.

FIG. 1 is a top view of a standard slalom water ski course.

FIG. 2 is a side view of a standard slalom water ski course (three buoys shown).

FIG. 3a is a side view of a “turn ball span.”

FIG. 3b is a side view of an “entry/exit gate span.”

FIG. 4a is a detailed view of a “boat guide bouy” with integrated “computer control system.”

FIG. 4b is a detailed view of a “boat guide bouy” with integrated “computer control system” with GPS receiver.

FIG. 5 is a detailed view of an example propulsion system for a “turn ball span” or “entry/exit gate span” with a “turn ball” shown.

FIG. 6 is a top view of six “turn ball spans” and two “entry/exit gate spans” in “maintain position” mode forming a standard slalom water ski course.

### DETAILED DESCRIPTION

### Standard Slalom Water Ski Course

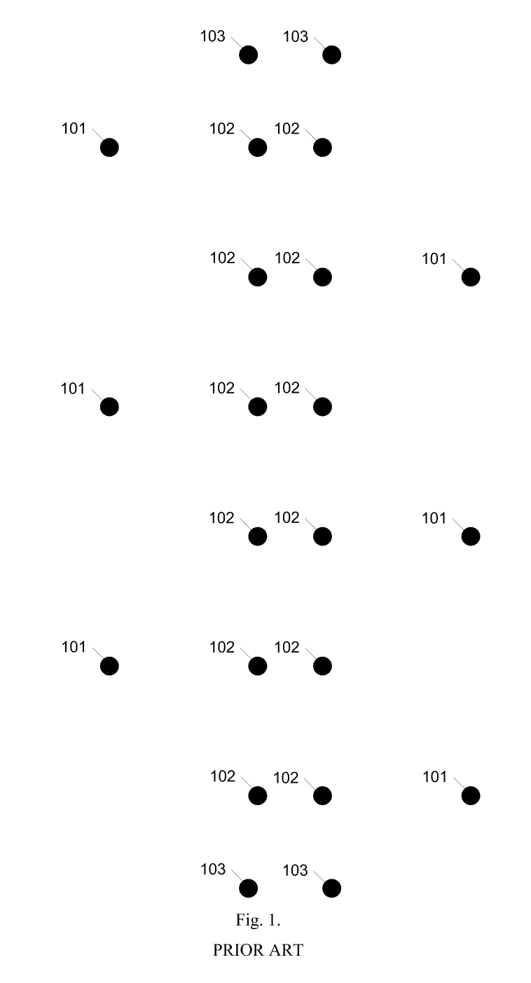

FIG. 1 shows a top view of a standard slalom water ski course layout. A standard water ski course length is normally 259 meters and is preferably is made of six pairs of boat guide buoys 102. Boat guide buoys 102 within a pair are normally separated by 2.3 meters, and pairs are normally separated along the course length 41 meters apart. An entry and exit gate buoys 103 are similarly separated by 2.5 meters, and are 27 meters from the nearest set of boat guide bouys. Also, there are six turn balls 101. The distance between a turn ball 101 and the nearest boat guide buoy 102 is normally 10.35 meters. The boat drives down the centerline of the water ski course keeping within the entry gate buoys 103, the six sets of boat guide buoys 102, and the exit gate buoys 103. The slalom water skier passes through the entry gate buoys 103 and then proceeds to ski around each of six turn balls 101 placed on alternate sides of the course and exits the course through the exit gate buoys 103. Normally the course can be navigated from either direction.

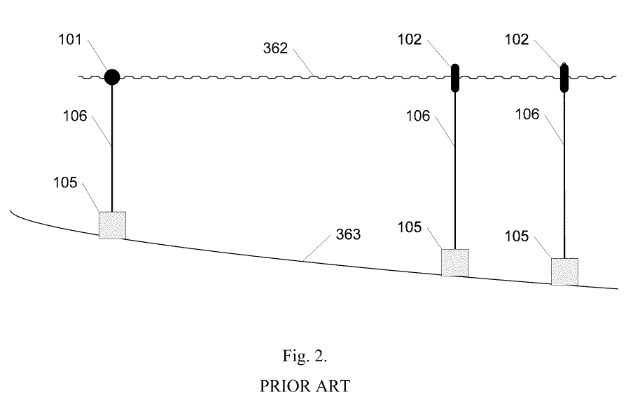

FIG. 2 is a side view of a partial standard water ski course with turn ball buoy 101 and boat guide bouys 102 at the water surface 362 using anchors 105 attached by ropes 106, cable, or chain to position each buoy. Normally, each buoy 101, 102, 103 is anchored to the bottom of the lake 363, or tethered to an anchored underwater framework of pipes, ropes, cables, and anchors to maintain the relative and fixed position of each buoy within the course.

While the invention preferably can deploy to form a standard slalom water ski course, the invention also can be used to form other types of water courses. Thus, the invention is not limited to the dimensions discussed above.

### Automatic Deploying and Positioning Slalom Water Ski Course

One embodiment of the system preferably includes six main “turn ball spans” with additional smaller entry/exit gate spans to provide entry and exit gates for the slalom water ski course. When deployed and in position, the spans preferably self align in such a way as to provide a slalom water ski course for use by a water skier. Other numbers of spans can be used.

### Description of a “Turn Ball Span”

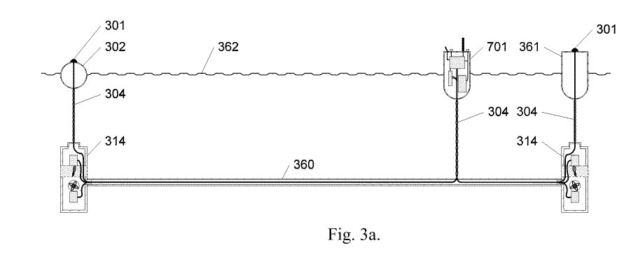

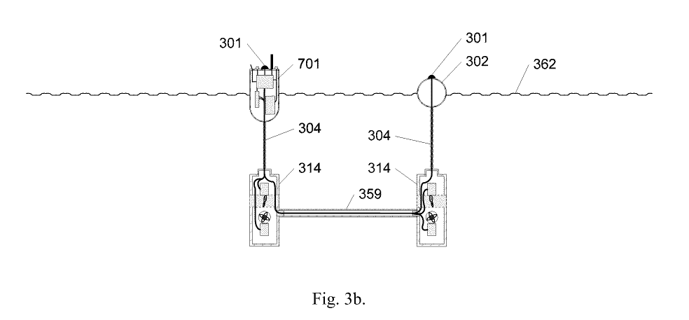

FIG. 3a shows a side view of a preferred embodiment of a turn ball span. Each turn ball span preferably includes at least a rigid underwater pipe 360 (approximately 12.65 meters in length for a turn ball span) made of plastic, metal, or other appropriate material, suspended approximately 1.25 meters below the surface of the water 362 by two “boat guide” buoys 701, 361 and 1 “turn ball” buoy 302 preferably attached by chain, rope, cable, or other appropriate attachment 304. At one end of the pipe 360 (end “A” on the right) the attached buoy 361 preferably acts as one of two boat guide buoys. The other boat guide buoy 701 preferably would be attached to the pipe 2.3 meters from end “A.”

The boat guide buoys 701, 361 preferably are similar to each other in color and shape but may be of different color or shape than the “turn ball” buoy 302 preferably attached at end “B” on left side of the pipe 360. When the turn ball span is in place, the boat guide buoys 701, 361 preferably provide a reference and guide through which the boat may pass, while the turn ball buoy 302 preferably provides the marker for the water skier to ski around.

In a preferred embodiment, a GPS receiver 301 is integrated into the top of the buoys 302, 361 at each end of the turn ball span. The GPS receivers 301 preferably provide position related information to the control system preferably housed within boat guide buoy 701. Also in the preferred embodiment, a propulsive device 314 is included at each end of the underwater pipe 360. The propulsion device 314 preferably allows the control system to independently control the position of each end of the turn ball span.

In the preferred embodiment, each pipe 360 may telescope, fold, or disconnect in such a way as to provide easier storage of the turn ball span.

Preferably, there would be six turn ball spans as described above. A different number of turn ball spans could be used, for example to provide different turn points for alternative paths through the course. In additional, the turn ball spans could use components having different dimensions and shapes than those discussed above. The turn ball spans also could use different combinations of components to achieve substantially the same results as those discussed above.

### Description of an “Entry/Exit Gate Span”

FIG. 3b shows a side view of a preferred embodiment of an entry/exit gate span. An entry/exit gate span preferably is 2.5 meters in length and preferably includes a pipe 359 approximately 2.5 meters in length suspended approximately 1.25 meters under the surface of the water 362 by buoy 701, 302 preferably attached by chain, rope, cable, or other appropriate attachment 304. One entry/exit gate span can preferably be positioned at the start of the course to provide the first set of boat guide buoys 701, 302 and the entry gate through which the water skier is expected to pass enroute to the first turn ball. A second entry/exit exit gate span would preferably be positioned at the end of the course to provide the last set of boat guide buoys 701, 302 and an exit gate through which the water skier is preferably expected to pass after rounding the sixth turn ball. In a preferred embodiment, the entry/exit gate spans mark the beginning and end of the water ski course.

In the preferred embodiment, each entry/exit gate span pipe 359 may telescope, fold, or disconnect in such a way as to provide easier storage of the span.

Preferably, there would be two entry/exit gate spans as described above. A different number of entry/exit gate spans could be used, for example to provide alternative entry/exit points for the course. In additional, the entry/exit spans could use components having different dimensions and shapes than those discussed above. The entry/exit gate spans also could use different combinations of components to achieve substantially the same results as those discussed above.

Equipment Preferably Included with Each Span

### Global Positioning System (GPS) Receivers

In a preferred embodiment shown in FIG. 3a, on each turn ball span, a GPS receiver 301 (or other appropriate location reference device) is preferably located on top of the boat guide buoy 361 at end “A” and a second GPS receiver 301 is preferably located at the top of the turn ball buoy 302 at end “B” to obtain and provide location information to the control system preferably within the boat guide buoy 701. FIG. 3b shows an entry/exit gate span, with a GPS receivers 301 preferably located on top of each buoy 701, 302. Location coordinates (lat/lon) and other appropriate information is preferably provided to the control system computer preferably within the boat guide buoy 701.

In a preferred embodiment, GPS receivers placed at each end of the span allow the computer control system to know the location of each end of the span and can use that information to position the span. Alternatively, other technology could be used to provide accurate location coordinates (and other appropriate information) of each end of each span.

### Span Propulsion Device

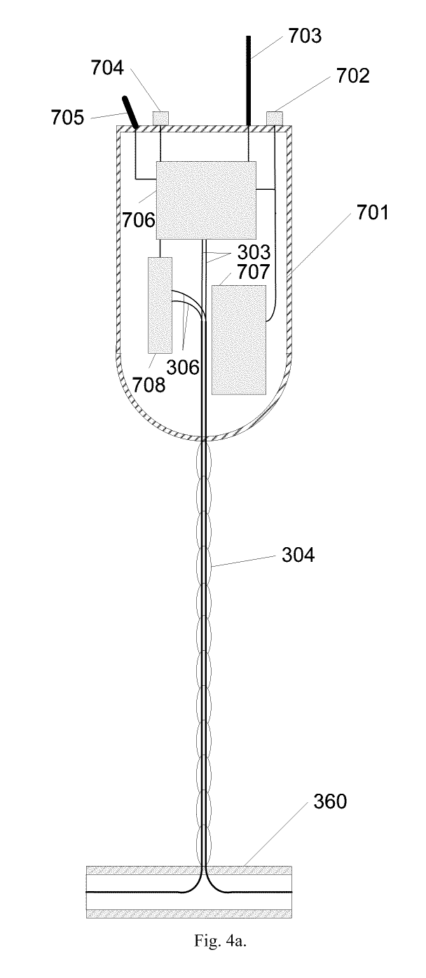

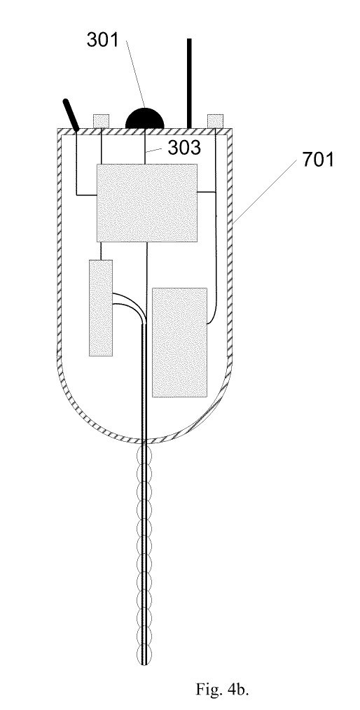

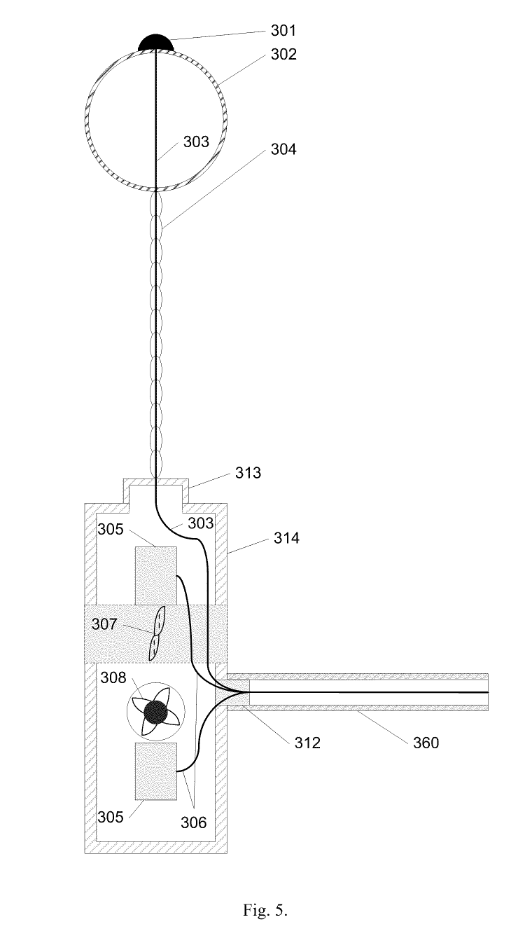

FIG. 5 shows a preferred embodiment of a propulsion device 314 and turn ball buoy 302. In a preferred embodiment, at each end of each underwater span is an underwater propulsion system 314 that allows independent control of each end of the span in any horizontal direction. In this embodiment, two propellers 307, 308 are fixed preferably perpendicular to each other and driven by preferably reversible motors 305 and preferably could act as the propulsion device. Each motor 305 is controlled preferably by separate control wires 306 that preferably connect to the computer control system (shown in FIG. 4a) through the pipe 360 (or 359 in the case of an entry/exit gate span). The computer control system can preferably independently control the motors 305 such as on/off, forward, reverse to control the position of each end of the span. This embodiment provides horizontal movement along two perpendicular axis. The propulsion device preferably would be under control of the control system. An access cap 313 would preferably allow access to the internal equipment. A plug 312 would preferably prevent water to gain access to the interior of the propulsion device. A wire 303 providing GPS information from the GPS receiver 301 preferably mounted on the turn ball 302 would preferably pass through the propulsion device 314 to preferably connect with the computer control system preferably via pipe 360. The propulsion device 314 is connected to the span by pipe 360, and is connected to a buoy 302 by a chain, rope or cable or other appropriate connection device 304. The Other propulsion devices could be used.

An alternative embodiment of a propulsion device (not shown) would have a propeller that could rotate in any horizontal direction. This would allow the control system to preferably maneuver each end of the span in any horizontal direction. The control system would also preferably be able to control the rotation of the propeller such as on/off, forwards/backwards, variable speed, etc.

### Span Control System

FIG. 4a shows a preferred embodiment of a battery powered computer control system preferably housed within a boat guide buoy 701. The computer 706 preferably would control the propulsion devices via on/off and forward/reverse controlling relays 708 connected to the computer via a serial port or other appropriate connection. The relays 708 would preferably in turn control the appropriate motors through wires 306. The computer 706 would preferably receive input from the GPS receivers 301 through a serial port (or other appropriate connection) via wires 303 on each span. The computer control system would preferably be turned on/off via switch 705 and would preferably communicate wirelessly via antena 703. Each span control system preferably would communication with the master control system (described later) by direct physical connection or wirelessly by an antena 703 (or other appropriate alternative). With wireless communication, each span would preferably communicate with other spans as described later in this document. A Universal Serial Bus (USB) port 704 would preferably be available and a charging port 702 would preferably allow the battery 707 to be recharged. The boat guide buoy 701 preferably would be attached to the underwater pipe 360 by a chain, rope, cable, or other appropriate attachment device 304. Other controls or components may be included.

FIG. 4b shows a battery powered computer control system housed within a boat guide buoy 701 which could be used as part of the entry/exit gate span with a GPS receiver 301 and alternative location of the wire 303.

Different control systems or configurations of control systems could be used.

The control system preferably would have previously stored lat/lon coordinates about the desired location of the individual span.

### Span “Maintain Position” Mode

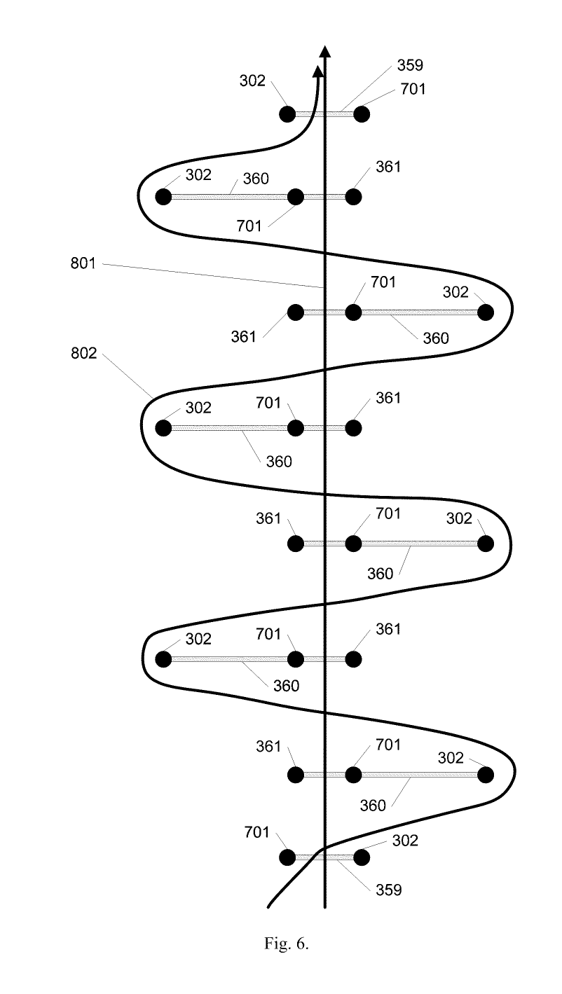

FIG. 6 shows a top view of a preferred embodiment of six turn ball spans (showing turn balls 302, the underwater pipe 360, and boat guide buoys 701, 361) and two entry/exit gate spans (showing bouys 302, 701 and the underwater pipe 359) in “maintain position” mode. Each span would preferably position and self align in such a way as to maintain the position of a standard slalom water ski course. Adjustments using one or both propulsion systems on each span preferably would keep the span in position and preferably would be able to react appropriately when moved out of position due to factors such as waves, currents, drift, wind, and contact with boats, people, animals or other things. This mode of operation is preferably engaged when the span is in position and ready for use preferably as part of an automatic deploying and maintaining slalom water ski course. The preferred path of the water ski tow boat is shown by arrow 801. The preferred path of the water skier is shown by arrow 802.

In a preferred embodiment, “maintain position” mode allows the computer control system to independently control each end of the span to make adjustments as necessary using one or both (or as many as necessary) propulsion systems as part of each span. In a preferred embodiment, the control system could detect via GPS that either end of the span has moved more than a predetermined distance from the desired location. The propulsion system preferably would then be engaged in such a way as to propel the span back to the desired location.

Factors affecting the span that would engage the maintain position functionality could include (but not limited to) water movement caused by currents, boat waves, etc, wind blowing the buoys and balls, direct contact to the span or buoys/balls by boats, people, animals, or any other factor that would cause either end of the span to move from the desired position. In addition, fluctuations in the accuracy of the GPS lat/lon coordinates could cause the control system to reposition the span.

### Span “Transport” Mode

Each span preferably would have the capability to move in to position from a common starting deployment point, and preferably return to that deployment point when use of the course is complete. In a preferred embodiment, while in transport mode, the span is moving towards a destination (such as a desired slalom water ski course location, or deployment point) at a significant distance (greater than approximately 5 meters). If the span is deployed at any significant distance from its desired location, the control system would preferably engage transport mode to efficiently and quickly get the span to the desired location.

To improve efficiency of movement over large distances, the span could move such that preferably end “B” of the span “leads the way” to the desired lat/lon location for that end of the span. While in transport mode, the other end “A” of the span would preferably position itself to “follow” the lead end “B” of the span, thus streamlining the motion of the span.

An entry/exit gate span could also support transport mode where preferably one end would “lead” and the other end would “follow.” When the span is within a predetermined and close distance from the desired lat/lon location the system preferably would switch in to maintain position mode as described above.

An additional fixed propeller may be included in the span design (such as extending from the propulsion device 314 shown in FIG. 5) to increase efficiency and speed while the span is in transport mode. This propeller preferably would engage during transport mode to provide additional thrust to the system, tending to make movement more efficient in the direction of end “B.”

### Other Modes

In some embodiments, the spans can operate in other modes. For example, the spans could operate in a “course reconfigure mode,” in which the spans would move from positions for one course configuration to positions for another course configuration. Other modes are possible.

### Master Control System

In a preferred embodiment, the master control system preferably includes a computer system that can preferably communicate with each span of the system. This may be wirelessly via WiFi or other appropriate wireless communication method, or by physical connection, or by other appropriate means of communicating between the master control system and each span.

The master control system preferably would have a user interface such that the user of the automatic deploying and maintaining slalom water ski course could interact with the system to preferably control operation of all spans. Information available to the user could include current lat/lon coordinates as reported by one or both GPU receivers, battery condition and charge level, current set lat/lon points for water ski course operating positions deployment points, and other appropriate information. The master control system may or may not be integrated within one of the spans. The master control system preferably would also provide information such as lat/lon coordinates, length of time for course to be setup, deployment points, course setup scheduling, and other related information.

A deployment point preferably is a common location from which all spans start prior to deploying to the specific location for each span. A deployment point preferably may also be the point where all spans automatically return after water skiing is complete. The master control system preferably would allow the user to mark the starting location and direction of a new water ski course, and store the location of previously set starting locations.

The master control system preferably would allow the user to determine the length of time to leave the automatic water ski course in position before returning to the deployment point. With the ability to communicate with each span (wirelessly, physically, or otherwise), the master control system preferably could communicate with each span while deployed to move the whole course, to return the course to the deployment point, or to extend or contract the course as described by the “beginner” mode later in this document.

Other types of master control systems with some, all, none, or additional functions than those described above can be used.

### Deploying Spans

In a preferred embodiment, the spans would normally be deployed from a boat, the shore, a dock, or other appropriate location of deployment. The deployment location could be marked by the master control system as a deployment point such that the automatic deploying and maintaining slalom water ski course preferably would return to the deployment point after water skiing is complete.

### Computation Considerations

In a preferred embodiment, the span is a rigid device. Therefore, the computer control system “knows” that each GPS receiver is a certain distance apart (such as the preferred length of 12.65 m for a turn ball span).

The control system preferably would receive simultaneous GPS readings from each GPS receiver and make position adjustments preferably by operating the propulsion devices to help control the current position of the span. GPS error could be reduced as a GPS reading is taken from each end of the span at the same time which could provide good relative accuracy between the GPS readings even if the specific accuracy of the readings is not accurate. In other words, if GPS accuracy in the area is off by 20 feet in any particular direction, if all GPS receivers are obtaining the same GPS signal at the same time, the error in accuracy could be similar for each GPS receiver.

The net effect of this is that the entire system should be “off” by the same amount in the same direction thus preferably keeping the relative position of each span (and buoys/balls). To an observer on a drifting boat, the water ski course preferably would remain in constant relative position, although the actual position may change slightly due to GPS error.

Differential GPS could be engaged to provide better accuracy. Turning off all differential GPS such as Wide Area Augmentation System (WAAS), could provide relative accuracy for each GPS receiver, although specific accuracy would be reduced. On the water, exact position accuracy may not be as important as the relative position accuracy of the spans that make up the water ski course.

To help address inconsistent readings other than those inaccuracies that affect all receivers in the same way, the control system “knows” that each GPS receiver preferably is a fixed distance away from each other which could provide help in resolving or better estimating current position. In one embodiment, if GPS readings from each end of the span show that the ends are 15 m apart, and the system “knows” that they should be 12.65 m apart, appropriate assumptions could be made by the control system when estimating the actual position of each end of the span. This could cause the system to alter position calculations such as (in the 15 m reading example above) “splitting the difference” and assuming that the actual location of each end is 1.175 m closer to each other at each end than reported. Distance readings much greater or less than 12.65 m apart could also be an indicator that the control system should wait longer for more accurate readings before adjusting the position of each end of the span based on those readings.

In a preferred embodiment, estimating the current position of each end of the span allows the control system to understand the difference between the current estimated position and the desired position and can engage the propulsion system appropriately to move each end of the span in the desired direction. Since the approximate location of each end of the span is preferably known, the appropriate propulsion angle could be calculated for each end of the span which preferably would position each propeller in such a way as to move each end of the span in to the desired direction.

### Battery

In a preferred embodiment, a rechargeable battery system would be available within the span to power the GPS receivers, the propulsion systems, the control system, and other appropriate electrical equipment. While transported in a vehicle or on a boat, the system could be charged by the vehicle charging system. Alternatively, each span could be charged by a wall charger, solar charger, or other appropriate charging device.

### Alternate Computer Control System, GPS Receiver, WiFi Antenna Location

In an alternative embodiment, each turn ball span could be lengthened by approximately 1-3 meters at one or both ends of a turn ball span (1-3 meters on one or both ends in the case of an entry/exit gate span) and additional buoys could be attached to the span at those locations to provide the computer control system, integrated GPS receivers, the WiFi antenna and/or any other equipment associated with this invention. This may be considered to reduce the possibility of damage to the computer control system, GPS receivers, or other equipment by the water ski tow boat or by the water skier. Occasionally, in a standard slalom water ski course, boats will damage the boat guide buoys and associated ropes or cables and skiers may damage turn balls by making direct contact with them. The intent of the slalom water ski course would be maintained.

### Alternate Usage

In a preferred embodiment, the master control system could allow the user to select a “beginner” mode which would preferably direct the spans to position themselves further apart than normal to allow a skier to more easily pass through a less aggressive course. Normally turn ball spans are preferably 41 m apart, while the distance between an entry/exit gate and the nearest turn ball span is preferably 27 m. In “beginner” mode, the course would expand in length by 20% (for example) which would provide preferably 49.2 m between turn ball spans, and preferably 32.4 m between entry/exit gate spans and turn ball spans. As the skier improved, the course preferably could be compressed until a standard slalom water ski course layout dimension is achieved.

In addition, with additional turn ball spans, the automatic deploying and maintaining slalom water ski course could be expanded in such a way as to provide more than the usual 6 turn balls within the slalom water ski course. For example, a “double course” could be made with 12 turn ball spans and 2 entry exit gates to further challenge the water skier with an extended automatic deploying and maintaining slalom water ski course.

The water ski course could be programmed to be positioned in other configurations to provide alternate courses for water skiers, wake boarders, or other water sports activities, competitions, or the like.

In addition, slalom water ski courses also may employ the use of 55 m gates. 55 m gates could be implemented by preferably additional entry/exit gate placed in line with the course and preferably 55 meters outside of the entry and exit gate spans. The 55 m gate provides help for the boat driver to line up with the course, and helps the water skier “get ready” for the entry gate by providing visual indication that the skier is approaching the entry gate.

### Wireless Communication

Wireless communication between the master control system and each span could allow communication of course location, deployment points, move the position of the automatic deploying and positioning slalom water ski course, and automatic recall when skiing is complete. The user could deploy, retrieve, reposition, or transmit other appropriate information to all spans by sending a wireless message to all spans.

Wireless communication between spans could further improve the accuracy of GPS by analyzing the GPS lat/lon signal from all receivers to reduce overall error within the system.

In a preferred embodiment, wireless communication between each span and the master control system could allow information to be relayed to the user such as battery condition, current location, and effort to maintain the current course location (current, wind effects etc.).

In a preferred embodiment, each span would have a method of communication other than via a wireless connection. This could be through a Universal Serial Bus (USB) port, or similar.

### Provisional Applications

The provisional applications from which this application claims priority are hereby incorporated by reference as if fully set forth herein. To the extent that the disclosures of those applications differ from this application, those differences represent alternative embodiments of the invention.

### Alternative Embodiments

The invention is in no way limited to the specifics of any particular embodiments and examples disclosed herein. For example, the terms “preferably,” “preferred embodiment,” “one embodiment,” “alternative,” “alternatively,” “exemplary,” and the like denote features that are preferable but not essential to include in embodiments of the invention. Many other variations are possible which remain within the content, scope and spirit of the invention, and these variations would become clear to those skilled in the art after perusal of this application.

What is claimed is:

1. A portable automatic deploying and positioning slalom water ski course that automatically deploys and maintains position.

2. The course as in claim 1, comprising at least one turn ball span and at least one entry/exit span.

3. The course as in claim 2, wherein the turn ball span, the entry/exit span, or both further comprises a location determination device, a control device, and a propulsion device.

4. The course as in claim 3, wherein the location determining device is a GPS device.

5. The course as in claim 3, further comprising a master control device.

6. The course as in claim 5, wherein the master control device wirelessly communicates with the control device for the turn ball and/or entry/exit spans.

7. The course as in claim 2, wherein spans in the course operate in at least a maintain position mode and a transport mode.

8. A method of using a portable slalom water ski course, comprising the steps of:
deploying the portable slalom water ski course from a deployment point, wherein the portable slalom water ski course automatically deploys into position and maintains position once deployed; and
activating the portable slalom water ski course to automatically return to the deployment point once a water skiing session is complete.

9. The method as in claim 8, wherein the portable slalom water ski course comprises at least one turn ball span and at least one entry/exit span.

10. The method as in claim 9, wherein the turn ball span, the entry/exit span, or both further comprises a location determination device, a control device, and a propulsion device.

11. The method as in claim 10, wherein the location determining device is a GPS device.

12. The method as in claim 10, further comprising a master control device.

13. The method as in claim 12, wherein the master control device wirelessly communicates with the control device for the turn ball and/or entry/exit spans.

14. The method as in claim 9, wherein spans in the course operate in at least a maintain position mode and a transport mode.
